(19) United States
(12) Patent Application Publication
(10) Pub. No.: US 2016/0162858 A1
(43) Pub. Date: Jun. 9, 2016

(54) SCREENING ARCHITECTURES ENABLING REVOCATION AND UPDATE

(71) Applicant: Verance Corporation, San Diego, CA (US)

(72) Inventors: Joseph M. Winograd, San Diego, CA (US); Rade Petrovic, San Diego, CA (US); Jian Zhao, San Diego, CA (US)

(21) Appl. No.: 14/960,212

(22) Filed: Dec. 4, 2015

Related U.S. Application Data
(60) Provisional application No. 62/087,757, filed on Dec. 4, 2014.

(51) Int. Cl. G06Q 20/12; G06F 21/10

(52) U.S. Cl. CPC G06Q 20/1235; G06F 21/10; G06Q 2220/10

(57) ABSTRACT

Methods, devices, systems and computer program products are provided to facilitate signaling of digital rights management (DRM) information that is carried within a multimedia content as digital watermarks. The embedded watermarks enable signaling of a change in trustworthiness of particular DRM technology, enable addition of new DRM technologies to a trusted list of technologies, and facilitate revocation of obsolete or untrustworthy technologies. Once a content is received at a receiver that is equipped with a watermark extractor, extraction of watermark symbols from the content allows the determination of change in trustworthiness of DRM technologies associated with the content.

### CROSS REFERENCE TO RELATED APPLICATIONS

This application claims the benefit of priority of U.S. Provisional Patent Application No. 62/087,757, filed Dec. 4, 2014, the entire contents of which are incorporated by reference as part of the disclosure of this document.

### TECHNICAL FIELD

The subject matter of this patent document relates to content management and more particularly to using embedded watermarks that enable digital rights management (DRM) changes, including revocation and update.

### BACKGROUND

The use and presentation of multimedia content on a variety of mobile and fixed platforms have rapidly proliferated. By taking advantage of storage paradigms, such as cloud-based storage infrastructures, reduced form factor of media players, and high-speed wireless network capabilities, users can readily access and consume multimedia content regardless of the physical location of the users or the multimedia content. A multimedia content, such as an audiovisual content, can include a series of related images, which, when shown in succession, impart an impression of motion, together with accompanying sounds, if any. Such a content can be accessed from various sources including local storage such as hard drives or optical disks, remote storage such as Internet sites or cable/satellite distribution servers, over-the-air broadcast channels, etc.

Some digital rights management (DRM) systems utilize digital watermarks for copyright protection of multimedia content such as audio, video, images and the like. In a typical watermarking scenario an auxiliary information is hidden within a host content in such a way that it is substantially imperceptible, and at the same time, difficult to remove without damaging the host content. The auxiliary information that is hidden within the host content can then allow content management to be carried out to varying degrees. Additionally, or alternatively, the auxiliary information can also be used for other applications, such as to monitor the usage of the embedded host content, resolve ownership disputes, and keep track of royalties and the like. For example, the embedded auxiliary information can identify the rightful owner(s), author(s) and/or author(s) of the content or can provide a serial number associated with the content or other content identifying information.

The above-mentioned proliferation of media platforms and devices poses a number of limitations and challenges to providing an effective content management across different platforms, devices and content formats.

### BRIEF DESCRIPTION OF THE DRAWINGS

FIG. 1 illustrates changes in digital rights management (DRM) status for different exemplary revocation and addition of credential in accordance with an exemplary embodiment.

FIG. 2(A) illustrates one exemplary watermark structure in accordance with an exemplary embodiment.

FIG. 2(B) illustrates another exemplary watermark structure in accordance with an exemplary embodiment.

FIG. 2(C) illustrates another exemplary watermark structure in accordance with an exemplary embodiment.

FIG. 3 illustrates a system architecture for an encrypted content playback.

FIG. 4 illustrates a system architecture for unencrypted content playback.

FIG. 5 illustrates a system architecture for an encrypted content playback in accordance with an exemplary embodiment.

FIG. 6 illustrates a system architecture for an unencrypted content playback in accordance with an exemplary embodiment.

FIG. 7 illustrates a high-level diagram of a software stack structure for implementing secure playback of a content in accordance with an exemplary embodiment.

FIG. 8 illustrates a system architecture with limited security functionality for content playback in accordance with an exemplary embodiment.

FIG. 9 illustrates a set of operations that can be carried out to signal a change in status of digital rights management (DRM) using embedded watermarks in accordance with an exemplary embodiment.

FIG. 10 illustrates a set of operations that can be carried out for determination of DRM status associated with a multimedia content in accordance with an exemplary embodiment.

FIG. 11 illustrates a block diagram of a device that can be used for implementing various disclosed embodiments.

### SUMMARY OF CERTAIN EMBODIMENTS

The disclosed technology relates to methods, devices, systems and computer program products that facilitate signaling, usage and implementation of changes in digital rights management (DRM) status of a content using embedded watermarks.

One aspect of the disclosed embodiments relates to a device that can be used as part of electronic device for dynamic signaling of digital rights management (DRM) status in a multimedia content. Such a device includes a processor and a memory comprising processor executable code. The processor executable code when executed by the processor configures the device to receive a content, and to embed a plurality of symbols in the content as part of one or more watermark messages that are designated for carrying DRM-related information. The plurality of symbols provide (a) an indication that a particular DRM technology has a credentialed status and is deemed to be trustworthy, (b) an indication that a credentialed status of a particular DRM technology has been revoked, or (c) an indication that a particular DRM technology has a restricted status and is deemed not be trustworthy. The one or more watermark messages designated for carrying the DRM-related information allow addition, deletion or update of trustworthiness status for a plurality of DRM technologies such that, upon extraction of the one or more watermark messages by a watermark extractor, the extracted symbols of the one or more watermark messages enable a determination of a change in trustworthiness of at least one DRM technology associated with the content.

Another aspect of the disclosed embodiments relates to a device that can be used as part of mobile device or a consumer electronic device for determination of digital rights management (DRM) status associated with a multimedia content. Such a device includes a processor and a memory comprising processor executable code. The processor executable code when executed by the processor configures the device to receive a content, and to extract a plurality of symbols of one or more watermark messages embedded in the content. The plurality of symbols designated for carrying DRM-related information enable the determination that (a) a particular DRM technology has a credentialed status and is deemed to be trustworthy, (b) a credentialed status of a particular DRM technology has been revoked, or (c) a particular DRM technology has a restricted status and is deemed not be trustworthy. The processor executable code when executed by the processor further configures the device to determine trustworthiness status of at least one DRM technology associated with the content based on the plurality of symbols that are extracted from the content.

### DETAILED DESCRIPTION

In the following description, for purposes of explanation and not limitation, details and descriptions are set forth in order to provide a thorough understanding of the disclosed embodiments. However, it will be apparent to those skilled in the art that the present invention may be practiced in other embodiments that depart from these details and descriptions.

Additionally, in the subject description, the word “exemplary” is used to mean serving as an example, instance, or illustration. Any embodiment or design described herein as “exemplary” is not necessarily to be construed as preferred or advantageous over other embodiments or designs. Rather, use of the word exemplary is intended to present concepts in a concrete manner.

As noted earlier, watermarks that are embedded in a multimedia content can be used for content management. In some embodiments, content management includes the management of the use of a content in accordance with one or more policies. For example, the auxiliary information that are embedded as a watermark may merely convey that the host content is not allowed to be copied (i.e., a “no copy allowed” watermark). Once such information is extracted and interpreted by a compliant device, copying of the content is prevented. A compliant device can include, but is not limited to, a device that performs screening, or otherwise operates in a manner consistent with a content use policy. Content use (or the uses of content) can include, but is not limited to, operations involving content such as playback, copy, record, transfer, stream, or other operations. Content screening refers to making a determination regarding whether the content use complies with a particular content use policy.

One type of watermark-based DRM system uses a type of watermark that is sometimes referred to as a Trusted Source (TS) watermark. In a typical implementation, the detection of a TS watermark by a watermark extractor signals that such a content can only be accessed if it has been received from a trusted source, or is in a particular format that is deemed to have originated from a trusted source. This, a TS watermark permits content containing the TS watermark to be used within an approved DRM only. One DRM system, known as the Advanced Access Content System (AACS), has established an approach to managing the TS watermark based on a list of approved content protection formats (credential) for content owner distribution of TS-marked content and a list of approved content protection formats for device playback of TS-marked content. AACS maintains alignment between the two lists, so credentials which have been added to the two lists are referred to as “whitelisted” because in so doing they become approved for carriage of TS-marked content.

Limitations of Existing AACS Approach

There are several limitations and challenges with AACS' approaches to TS credential management.

Pre-Approval:

The success of AACS' approach implicitly requires that any new content protection system that will ever be used to distribute TS-marked content be whitelisted in advance of commercial deployment in any product that could screen such content. This is because products manufactured in advance of such approval will be required to block playback of TS-marked content carrying that protection. If the approval was subsequently obtained, and legitimate TS-marked content was distributed using that protection, the legitimate content would be blocked from playback on the earlier-manufactured devices.

Revocation:

AACS' approach does not provide a general process for revoking the whitelisted status of a compromised credential. The circumstance in which the whitelist status of a credential needs to be revoked is when pirates are able to forge the credential such that TS protection is not enforced for pirated copies of TS-marked content. With AACS' approach, if a whitelisted credential is forged, the credential would only be removed from the whitelist if legitimate TS-marked content were not distributed with the credential. Thus, any new devices that are built subsequent to the removal would block playback of any such legitimate TS-marked content.

Next Gen TS Management

AACS Approach:

AACS defines a whitelist of Trusted Source Mark Allowed Technologies (TSMATs) accompanied with a list of rules on how to add new technologies to this list. This approach has several issues associated with it, as described above. One issue that will be addressed in this disclosure is that the whitelist includes only DRMs that can logically appear on optical sources, while DRMs that are used in other architectures are omitted regardless of their trustworthiness. Another issue with the AACS approach to be addressed in this disclosure is that if a whitelisted DRM gets compromised it creates a permanent piracy laundry channel as long as any legitimate content has been using this DRM, and it is undesirable to allow legitimate content to be blocked. The solution to this problem is to revoke DRMs per content, i.e. to carry revocation information within the content. Finally, due to the absence of a revocation mechanism in the AACS approach, the logic of adding DRMs to the whitelist is very strict. Adding some DRMs to the whitelist may become controversial, which may lead to releasing content without marks in parallel with (or earlier than) Blu-ray disc (BD) releases, which opens the possibility for audio swapping attacks. As an example, some multimedia distribution software cannot qualify for AACS whitelist since, while they are often used by streaming services, it can be relatively easy for pirates to get a license for the encoder software.

The following description uses the Cinavia® watermark as a working example to facilitate understanding of the disclosed embodiments. However, these principles can be applied to other watermarking technology besides Cinavia®.

Solution 1:

In some embodiments, a first architecture utilizes reserved bits an existing watermark payload to carry information about the Whitelist Version (WV). Such an existing watermark payload with reserved bits can be the 8-bit watermark payload present in the watermark technology known as Cinavia®, which is available from Verance Corporation and which is specified in the AACS Adopter Agreement. Cinavia® is one example of a watermark that may be adapted to implement the techniques of the disclosed embodiments. Other watermark technologies may also be employed. In some embodiments, the existing AACS whitelist corresponds to WV=0, but a new DRM can be added to the current whitelist, as long as 1) existing devices that are Cinavia-compliant are not able to decrypt the content protected by this DRM; or 2) no existing devices that are Cinavia-compliant perform screening on the content protected by this DRM (to avoid enforcements of legitimately obtained content on legacy devices). New DRMs can also be added to any WV without any system changes.

Only when a whitelisted DRM has been compromised, and used as a piracy laundry channel, it is removed from whitelist, and a new WV should be created. With 3 reserved bits, up to 7 revocation opportunities are possible. Note that devices also need to be informed about the content of the new whitelist. Devices that aren't updated will allow pirated content packaged into compromised DRM.

If the process of adding DRMs to the whitelist is quite liberal, then the limit of up to 7 revocation opportunities can become an issue. In particular, this can present a situation where different content owners have different revocation preferences that need to be reconciled. Furthermore, consider the scenario where a previously compromised system has been “repaired” and then added to whitelist again, under a different version number. If this repair turns out to be unsuccessful, another WV would be needed to revoke this version too. So, a single DRM could use up all revocation opportunities rather quickly.

Finally, the reserved bits in the 8-bit payload of Cinavia® can be used alternately to flag different content licensees, similar to AACS flag. For example, an industry consortium such as Secure Content Storage Association (SCSA) or a major content consumption ecosystem may ask for a flag that would identify content owners that are licensees, and allow devices in the consortium or ecosystem to protect only content from participating owners. Such an allocation of the reserved bits in 8-bit payload of Cinavia® would severely limit the number of revocation opportunities in the above described Solution 1. Accordingly, while Solution 1 provides a viable options for some implementations, it may not be the preferred approach in other implementations.

Architecture:

In the simplest terms, the Whitelist Version is a counter of the number of times a group of one or more previously approved DRM credentials (“credentials”) was revoked. In some embodiments, each version of the Cinavia® Specification is associated with a Whitelist Version. The present version and all previous versions at the time of introduction of this feature into Cinavia® are associated with WV=0 (i.e., the “current” Whitelist Version).

A reserved field in the watermark (e.g. Copy Management (CM) Payload bits R0-R2) is designated as the Content Whitelist Version (CWV) field which carries an integer value (e.g. 0-7). Values are assigned such that all previously marked content carries CWV=0 and all version updates of the Marked Content Specification will require that newly marked content be marked at the current WV or lower.

For each Whitelist Version, a Distribution Credential List (DCLn, where n is the associated Whitelist Version) is maintained including credentials which have been identified as meeting content owner (e.g., movie studio) requirements for carriage of Trusted Source content. The Cinavia Marked Content Specification prohibits content owners from distributing TS-marked content in any format not on the DCL associated with the CWV embedded in the content. That is, content marked with TS state and CWV=n may only be distributed with credentials listed in DCLn. At the outset, DCL0 contains a listing of an initially approved AACS technologies.

Similarly, for each Whitelist Version, a Restricted Credential List (RCLn) is maintained of credentials which have been identified as currently known formats for use in carriage of pirated content. Note that appearance on the RCL list leads to TS screening being applied to content with the listed credential. Devices apply the RCL associated with the WV indicated in the CWV field of the content being screened. That is, content marked with TS state and CWV=n is screened according to RCLn. If the CWV indicates a WV that is higher than that of the device (e.g. a “future” WV), then the device screens using its current WV (e.g., the WV under which it was manufactured). RCLs would be set forth in the Cinavia® Detector Specification. At the outset, RCL0 contains Unencrypted content, SSL, HLS, and AACS Recordable Video.

Adding to the Distribution Credential Lists:

The credentials of content protection systems which are identified as meeting the initially AACS approved technologies can be added to any DCL in a version update of the Cinavia Marked Content Specification so long as that credential is not on the RCL of the corresponding WV or a previous (lower numbered) WV. Note that the members of a specific DCL may change between different versions of the Cinavia Specification.

When a credential is added to a DCL, it can (but is not required to) be added to the DCL of all prior (lower numbered) WVs.

Making an addition to a DCL does not require that a new WV be created.

Adding credentials to DCLs in this way enables TS-marked content to begin being distributed with the newly added credential and ensures playability of the content on devices manufactured under any specification version.

Adding to the Restricted Credential Lists:

Credentials which are identified as being used (or likely to be used) for “laundering” TS-marked content can be added to any RCL in any version update of the Cinavia Detector Specification so long as that credential is not on the DCL for the same WV or a subsequent (higher numbered) WV.

When a credential is added to an RCL, it can (but is not required to) be added to the RCL of all subsequent (higher numbered) WVs.

Making an addition to an RCL does not require that a new WV be created.

Adding credentials to RCLs in this way ensures that all content released TS-marked under the modified WVs will be protected against the identified laundry channel content in devices which conform to the revised Cinavia Detector Specification.

Revocation:

Revocation occurs when a credential which was previously approved for distributing legitimate TS-marked content becomes compromised such that it is or can be used as a laundry channel for pirated TS-marked content. To revoke a credential, a version update to the Cinavia® Specification is issued which defines a new, incremented WV for which the DCL and RCL are newly established. Typically, the new DCL and RCL of the new WV are the same as the prior generation with the revoked credentials moved from the DCL to the RCL. The DCL of the new WV is prohibited from including any credentials that are included in the RCL of a previous WV.

Defining a new WV in this way permits new releases of content TS-marked to be protected against laundry channel attacks using the revoked credential in devices manufactured under the revised specifications and legitimate copies of this content will be playable on all devices. Content marked and released under earlier WVs will continue to be playable on all devices and will not be protected against laundry channel attacks using the revoked credential.

Note also that it is possible to revoke a credential without defining a new WV if no TS-marked content at a given WV (or higher) has been distributed using the credential. In this case, a version update of the Cinavia Specifications is simply issued with the credential removed from the DCLs of the lowest WV (and any subsequent WVs) in which no TS-marked content has been distributed.

Extension of the Content Whitelist Version Field:

If a whitelist version update causes the incremented WV to reach the highest value supported by the CWV field of the CM Payload, the version update would define an additional field in a watermark payload to extend the range of representable WVs, and the highest value of the CWV field of the CM Payload indicates that the additional field be used for carriage of the extended CWV.

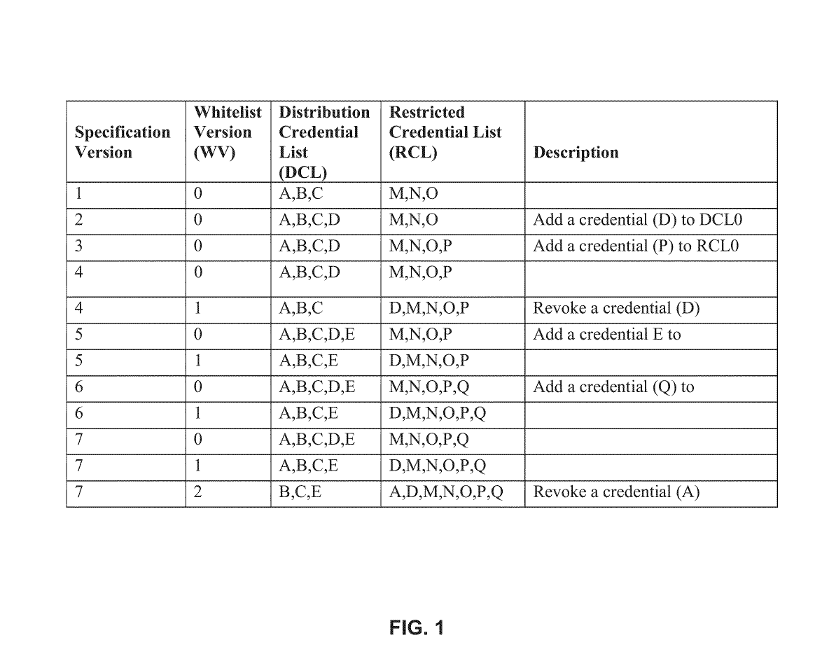

FIG. 1 illustrates an exemplary table of WV, DCL, and RCL values for seven specification versions in accordance with an exemplary embodiment. In FIG. 1, the letters A-Q represent credentials, and the table heading “Description” provides an explanation regarding additions or deletions to the lists. In particular, each new version of the Specification (i.e., a new version number) requires the device to be compliant to the WV, DCL, and RCL that are specified in such a Specification. In some embodiments, WV is an 8-bit watermark payload (i.e., Cinavia reserved bits).

Solution 2:

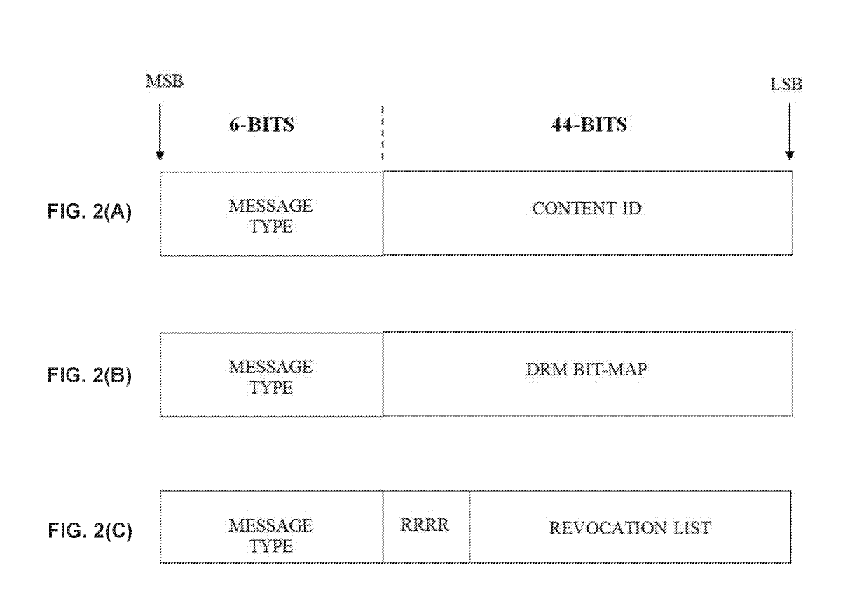

In some embodiments, a second architecture utilizes the watermark payload (e.g., the existing 50-bit Extended Payloads (EP) present in Cinavia®) to carry whitelisted/revoked DRMs information. Note that a 50-bit payload is currently used in Cinavia® for Content Identification (CID) as illustrated in FIG. 2 (A)). This 50-bit payload is divided in two parts, where the first part is a 6-bit Message Type (MT), and the MT value (bx000000) indicates that remaining 44 bits are used for content ID message. However, not all embedded content ID payloads are typically required for proper identification of the content, and thus some of the content identification payloads can be replaced with payloads carrying the DRM-related information. For example, there are about 200 50-bit payloads in a typical TS use case, known as “long content”, where the grace interval (i.e., maximum allowable unrestricted use of a marked content) is 20 minutes, and so there are enough opportunities to interleave CID and DRM information, e.g. in a 50/50 split. Theoretically, it is possible that the TS enforcement condition is met before the EP watermark (which is used to carry DRM information in the above approach) is detected (e.g., TS-marks are detected from a content that is not protected by a DRM on the TSMAT in the manner that meets a specified “enforcement logic”). However, this scenario is highly unlikely in undistorted content, or content that is undergoing regular transcoding.

For the case of a missing EP, when TS enforcement condition is met, in some embodiments, a default whitelist is provided, which corresponds to WV=0 in the previous solution (for example, WV=0 may comprise the AACS whitelist, plus reliable non-optical DRMs, like Verimatrix, Vudu, etc.). So, in the case that an attacker tries to remove EP watermarks without removing the Copy Control Information (CCI), the player reverts to the legacy device behavior.

For the above-described solution, the watermark provider, such as Verance, can maintain a DRM table with a list of all applicable DRMs, where the index into the table represents a DRM code. Different versions of the same DRM may have distinct codes. It may be difficult to estimate the size of the list in view of many DRMs that have versions that are obsolete (not used any more) or are thoroughly compromised like Content Scrambling System (CSS) used in Digital Versatile Disc (DVD) technology. One estimate is that a couple of dozen codes may suffice, and 256 codes can be enough as an upper limit (e.g., an 8-bit storage or messaging field size used for communicating the DRM codes).

There are two variations of the above-noted architecture described in connection with Solution 2.

First Variation:

In the first variation, the EP explicitly carries the whitelist information as a Boolean vector (e.g., as a bitmap), where bit=1 at position that corresponds to the DRM code means that, e.g., DRM is trusted, and bit 0 means not trusted, as illustrated in FIG. 2(B). The first 44 DRM codes can be carried in the EP, e.g. with MT=2, next 44 codes with MT=3, etc. Generally, a subset of MT codes not used for other purposes can be used to indicate bit-map type of message. This solution alleviates problems of limited number of revocations in solution 1. It also allows different content owners to make different selection of trusted DRMs by setting 0 or 1 in the Boolean vector for all DRMs carried by the EP in a specific content. Furthermore different content can have different selection of trusted DRMs. e.g. when previously trusted DRM is compromised then subsequently released contents could list this DRM as untrusted.

The devices need to know the DRM table to match the codes with EP bits. When the player manufacturer wants to add a new DRM, it can ask the watermark provider, such as Verance, for a new DRM code and update the DRM table in devices. The list of trusted DRMs is explicitly listed in the watermark payload, not in a separate table that requires firmware update to be present in the device. Thus, that there is no need to update firmware in order to block a DRM that is compromised and used as a piracy channel. If a DRM is compromised, and content owner wants to list it as not trusted, then for any newly marked content, the corresponding bit carried by the EP payload can be set to 0 (i.e., not trusted). Note that compromised DRMs can still be used in a piracy channel for previously marked content.

In some embodiments. EP bits that correspond to undefined DRMs at the moment of embedding of watermarks can be set to one, meaning that new DRMs are implicitly trusted. The objective is to prevent an old content (i.e., a content marked before the new DRM is evaluated) from triggering a TS enforcement when played on new device. This implicitly means that new DRMs need to go through some approval process by the watermark provider, such as Verance, to avoid the scenario of defining a new DRM just to create a piracy channel for an old content.

On the other hand, if content owners insist that they cannot trust the watermark provider to control playback of the old content converted to new DRMs, in some embodiments, all undefined DRMs can be considered as untrusted by default. In this case, content owners would be obliged to re-embed the old content if it is to be released with a new DRM, and they should carefully consider the possibility of conversion of old content to new DRM in a legitimate distribution channel, e.g. a new Conditional Access (CA) system.

In some embodiments, the unused DRM field split into two parts: one field has a default value 1 and the other has a value of 0. When a new DRM candidate is considered, the decision is made as to whether to put it in the place where old content is not expected to show up for playback (e.g., formats that don't allow transcoding) or where transcoding of old content is expected (new CA system), and then decide to use index in the DRM table where old content has 0 or 1 value.

Note further that the matching of the DRM code (which identifies the DRM and its version) and the EP DRM vector (which specifies whether the DRM is trusted or not) can be done either in the player or in the detector. The detector can be implemented as a firmware component, platform kernel, or secure environment within the player, and is often associated with a higher level of associated security. When the matching is done in the player, the player initially sends an Enforceable Payload List (EPL) to the detector based on the current ATSC white list. However, if during the grace period, the detected DRM vector indicates that DRM (used to protect the particular content instance) is trusted, the player should change EPL to indicate that TS mark should not be enforced. Alternatively, instead of the EPL, the player may deliver the DRM code to the detector, so that the detector can decide to comply with the TS enforcement when the detected DRM vector indicates that the DRM used to protect the particular content instance (as indicated by the DRM code provided by the player) is untrusted, or to stop TS enforcements otherwise. The latter approach requires the detector to include the needed logic to conduct those operations, and reduces the burden of implementation of such logic in the player. Thus this approach may be preferred (and more easily adopted) by the player implementers.

There is also an issue of legacy BD players enforcing on DRMs which in a next gen system may be considered by some content owners (e.g., movie or music studios) for whitelisting. Examples may include CSS without AACS signature, or new DRM systems such as Adobe Access. With the above described new architecture in place, content owners may consider that it is desirable to skip AACS signature, and release TS marked content on DVD with CSS protection but without AACS signature. Although CSS is broken, a large majority of pirates do not bother to encrypt a pirated content. Having in mind that misused DRMs can easily be put back on a blacklist, it is doubtful that pirates would invest in CSS encryption. So, it may be desirable to set a sunrise date for upgrade of all devices to new logic. Up to the sunrise date the content owners are obligated not to release content in DRMs that are deemed untrusted on legacy devices, while device manufacturers are obligated to prepare firmware upgrades for all legacy devices to allow users to overcome TS enforcements after the sunrise date.

Second Variation:

In the second variation of the architecture describes in connection with Solution 2, the list of revoked DRMs are communicated inside the EP. This is illustrated by FIG. 2(C). Again, multiple message type codes are used to indicate that subsequent bits are used to carry a revocation list message, which can increase the number of revoked DRMs. In the example in FIG. 2(C), DRM code is assumed to be 8 bits long, and thus five full DRM codes can fit into a 44-bit message, with four top bits left as reserved (labeled as RRRR it FIG. 2(C)). Provided that the list of revoked DRMs is short, fewer message type codes are needed for revocation lists than for DRM bit-maps. The main unknown is how broad is the initial whitelist, and how many DRM codes are dedicated to weak DRMs such as unsigned CSS. If it is desired to be liberal with placing DRMs in the table, the revocation list may be long from the very start. Then every new compromised DRM requires another 8 bits from EP space, and only one bit from the DRM vector (assuming adding repaired DRM release). Hence, the first variation described above may be preferred in the long run. Yet, both variations may be defined and implemented in detectors by just using different MT values. One of them may be adopted in watermark payloads in a marked content, and the player need not know which version is used; all it needs to carry is the DRM table and pass the DRM code used to protect the particular content instance to the detector. This also allows different content owners to adopt different version of the second solution for different content.

DRM Status Updates

The above-described solutions provide for the flexible approval or revocation of DRMs in view of TS status. However, a number of issues remain to be addressed. In particular, these issues include:

(a) How to classify existing DRMs, and in particular, those that aren't placed on the AACS whitelist (TSMAT). Some of those DRMs aren't expected to be encountered from optical drives, and some others may not meet AACS TSMAT criteria.

(b) A procedure is needed for revoking TS status for compromised DRMs in order to prevent having a permanent loophole in the watermark protection. However, any marked content that is legitimately released in compromised DRM has to be playable on all players.

(c) Procedures are needed for classifying new DRMs and/or DRM versions and informing legacy players about the status of new DRMs, while considering the scalability of the proposed solution as DRMs proliferate.

(d) Procedures may be needed to track and classify new DRMs in a timely manner to prevent friction with DRM developers and player manufacturers.

(e) Considerations resulting from the case where different content owners have different DRM classifications. Since, in this case, there is a potential for confusion among content distributors and users, methods to minimize the impact of such differing classifications exits are needed.

(f) The impact of existing marked content being repackaged into new DRMs must be considered.

(g) Attack vectors that attempt to confuse the player about the status of a particular DRM need to be addressed, assuming that the identity of the DRM is securely established by the player.

Design Outline:

In the description that follows, it is assumed that the watermark provider, such as Verance, maintains a public list of DRMs, which may be known as the “Watermark provider DRM list.” On top of the list, the 12 TSMATs listed by AACS are provided. Subsequent DRMs to be added to the existing 12. For example, DRMs listed in positions 13 through 16 of the list can include:

13. Kaleidescape DRM, version XX and higher

14. Vudu DRM, version XX and higher

15. Verimatrix CA, version XX and higher

16. Adobe Access, version XX and higher.

In the above, version numbers (XX) are particular version numbers.

Once a DRM is on such a list, the provider of such DRM may be required to inform the watermark provider of any version update, attacks, version compatibility, robustness rules, and major feature updates. Additional DRMs are added to the list as the watermark provider becomes aware of them. The watermark provider may proactively collect information about creation of new DRMs, but also may oblige manufacturers of compliant products to inform them whenever a new DRM is added to their player. New versions of the DRMs already on the list do not need a new entry in the list, as long as the older version is not compromised. For example, item 2 on the list is “Open Mobile Alliance (OMA) 2.0 and higher,” which allows for future versions of OMA to be included. If certain version of OMA DRM is compromised, as established by the watermark provider or any studio, the DRM vendor should be informed that its TS status may change for future content. If, or when, a new OMA version is released to patch the loophole, then a new item is added onto the list as “OMA x.x and higher”, while item 2 becomes “OMA versions below x.x”. It is desirable for the watermark provider to actively monitor piracy attempts to compromise DRMs, but the watermark provider can also accept requests from certain entities, such as content owners, to treat a certain DRM version as compromised, and add a new element to the list when the DRM vendor patches the loophole to the entity's satisfaction.

The Index into watermark provider DRM list is also known as the DRM code, which can be expressed as an 8-bit unsigned integer. Note that in view of the fact that new versions of existing DRM get assigned new codes only after successful patching of the compromised DRM version, the proposed maximum of 255 DRM codes are considered sufficient. If further study shows that this is not enough, it is possible to increase the maximum number of DRM codes. For example 11-bit codes would provide labeling up to 2047 DRMs and fit four revocations per EP. Compliant products should have a list of DRM codes for all DRMs handled by the product, and pass the code to the watermark detector prior to playback of the protected content. Content that is not protected by any DRM is signaled by DRM code zero. Any DRM for which the watermark provider DRM code doesn't exist can be treated as “Untrusted.” Product manufacturers should be aware of this fact, and in any licensing agreement they should be obliged to inform the watermark provider if they are using DRMs that aren't on the watermark provider DRM list. This is also in their best interest to avoid customer complaints.

In the above architecture, revocation of TSMAT status of a compromised DRM is communicated to the detector using watermark payload. This way, only the marked content that is released after a DRM revocation is subject to watermark TS enforcement if packaged into compromised DRM, while content released prior to the DRM revocation is still playable without enforcements on all players. Note that revocation of a DRM doesn't require any updates to players.

DRM revocation information can be carried using Extended Payloads (EP). As noted earlier, in some embodiments, the EP consists of two fields: a 6-bit Message Type (MT), and a 44-bit Message. There are two mechanisms that can be used to carry DRM revocation to detector, known as “bit-map revocation” and “explicit revocation”, described above as variations one and two of the Solution 2. In some embodiments, MT codes in the range [a, b] are used for bit-map revocation, and MT codes in the range [c, d] are used for explicit revocation. The detector recognizes both types of revocations, and acts accordingly, but in a particular content only one of the two types of revocation is embedded.

In bit-map revocation, MT=a signals that 44 message bits correspond to the first 44 DRMs on the watermark provider DRM list (e.g. the second bit corresponds to “OMA DRM 2.0 or higher”). MT=a+1 corresponds to next 44 DRMs on the list, etc. Bit value “1” indicates that the corresponding DRM is trusted, while bit value “0” indicates that the DRM is revoked. In some implementations, all unused bits (i.e. the bits with no entry in watermark provider DRM list) are set to “1” indicating that all future DRMs are treated as trusted.

In explicit revocation, MT=c indicates that 44 message bits carry a list of revoked DRMs. So, in the case of 8-bit DRM codes, up to five distinct DRMs can be explicitly revoked. Unused bits are all zero. If more than 5 DRMs need to be revoked, MT=c+1 carries the list of the next five revoked DRMs, etc.

The selection of the revocation mechanism as well as revoked DRMs is done by the watermark provider in consultation with content owners. In particular, it should not be subject of embedder operator's choice. When there is a need to revoke a DRM, it is achieved through embedder update, upon mutual agreement between the watermark provider and the content owner. In the presence of the flexible revocation option, content owners are encouraged to add DRMs liberally to the TSMAT list, so that content released in all distribution channels is marked properly to prevent audio swapping. Only if a DRM is indeed used as a laundry channel, the DRM is revoked, and each content provider (e.g., move or music studio) can decide independently about the revocation.

In the above architecture, each content owner is obliged to inform all its content distributors about the revoked DRMs, and ask them not to package the marked content into revoked DRM. The watermark provider also provides distributors with tools to extract the list of revoked DRMs from content. Furthermore, the watermark provider keeps track of revocation differences among content owners, anticipate potential mistakes that could lead to marked content repackaging into revoked DRM, and makes this information available to both content owners and distributors.

Both content owners and distributors are aware of the fact that DRMs not on the watermark provider DRM list are treated as untrusted. Thus, if either the content owner or the content distributor is aware of a new DRM, which is not on the watermark provider DRM list, they should contact the watermark provider and ask for a prompt assignment of the watermark provider DRM code. Since DRM revocation is in place, the watermark provider can liberally assign new codes to new DRMs, without too much investigation, and advise content owners to revoke those DRMs only if new DRM is indeed used as a laundry channel. Furthermore, content owners and content distributors should inform the content provider whenever a new version of revoked DRM is issued, which meets their criteria of putting it back on TSMAT list, so that the watermark provider can issue a new code for this DRM version.

If the watermark provider's detector doesn't detect any MT that carries the revocation information, it can apply the default whitelist, stored as 256-bit long bit-map, where “1” indicates trusted DRM and “0” indicates untrusted DRM. For example, all AACS TSMATs, as well as some other DRMs that have been accepted by the content providers and widely used, can be placed on such a default trusted list, while all others are untrusted. In this way, an attack that removes the EP watermarks, without removing the copy control (CCI) watermark, is not going to bring any benefit to attacker. However, if a DRM from the default whitelist is compromised, then erasure of the EP, together with packaging the content into the compromised DRM, becomes again a valid attack. In this case, the default whitelist may be updated either for future devices or by a firmware update. However, it may be that this type of attack is only a remote possibility.

In some implementations, when the detector gets the DRM code from the player, it starts screening content while assuming the default whitelist; i.e., it treats all DRMs outside default whitelist as untrusted. When an enforceable TS code is detected, the enforcement logic is activated, but enforcement conditions (e.g., as defined in AACS documents) haven't been met, the detector searches for revocation-EPs (i.e. with MT in [a, b] or [c, d] range) and saves them. Each saved code has an associated counter, and if the same EP is detected again, the counter is incremented. Up to eight different codes and counters can be available, and if a ninth distinct revocation-EP is found, it can replace the code with the minimum count. If the grace interval is reset (e.g., as defined in AACS documents) before the enforcement condition is reached, all saved EPs and counters are reset.

When the enforcement condition is reached, the detector first examines the integrity of the collected EPs. If some MTs are in [a, b] range and others are in [c, d] range, those in minority are rejected. If there are multiple codes with the same MT, then all are rejected except the code with the maximum count. After that, the DRM status is evaluated.

If no revocation-EPs are found, the TS enforcement event can be reported to the player. If revocation-EPs are found, and MT indicates bit-map revocation, the enforcement event is triggered if DRM code points to bit location with value “0,” or else the enforcement is canceled, and saved EPs and counters are reset. If explicit revocation is used, the enforcement event is issued if the DRM code appears on the revocation list, or else the enforcement is canceled, and saved EPs and counters are reset.

It would be desirable for the revocation scheme to be able to identify and revoke a large number of DRMs. To determine the upper limit on number of DRMs that can be specified and revoked, it is noted that the first limitation is on number of EPs that can be transmitted during a grace interval. For the so-called long content (as defined in AACS documents), there are about 200 EP slots per 20 minute interval, but for the so-called short content (as defined in AACS documents), this number drops to 100 (in 10 minute grace interval). In view of the fact that not all content supports watermarks, and that some watermarks can be lost due to content processing operations such as compression, it is desirable to budget some redundant embedding. Hence, conservatively, a reasonable limit is to use up to 16 distinct EP codes for revocation, where each code repeated 5 times, with 20 EP codes left for carrying the CID in a short content.

With the bitmap revocation approach 16 distinct MT codes can be used and up to 16×44=704 DRMs can be specified, where each of them can be revoked.

With explicit revocation, multiple variants of the implemented technique allow for different tradeoffs between DRM list length and the maximum number of revoked codes. For example, MT=c can signify that the DRM list is 2048 elements long. Each EP can carry 4 fields of revoked 11-bit codes, for a maximum number of 4×16=64 revoked codes.

Next, MT=c+1 and MT=c+2 would signify that DRM list is 1024 bits long. For MT=c+1, the subsequent 44-bit field covers codes from 1 to 512, so that the top 4 bits carry 4 MSBs of the revoked DRM codes, while the remaining 40 bits are divided into 8 groups of 5 bits, each group carrying 5 LSBs of revoked code. Similarly, MT=c+2 is used to revoke DRMs listed as 513 to 1024 on the list. So, up to 8 DRMs are revoked per EP for a total revocation capability of 8×16=128 codes. Based on the above, the list can include up 15 to 2048 DRMs, and up to 700 revocations, depending on which scheme is used.

A High-Level Architecture for Cinavia Implementation in ARM TrustZone-Enabled Architecture

This section summarizes the security requirements for Cinavia implementation, and proposes example high-level architectures of Cinavia implementation at the platform level in a typical system that incorporates the ARM TrustZone technology.

Introduction:

Cinavia is a copy protection technology platform that employs Verance's proprietary audio watermarking techniques to enable the communication and enactment of use policies for audiovisual content across a broad range of distribution channels and devices.

Cinavia Detector is one of the components of Cinavia, which is responsible for watermark extraction from the audio component of audiovisual content. Cinavia Detector is activated in compliant systems only for the usage of audiovisual content playback (“AV Playback”).

TrustZone is a security feature of ARM's processor architecture. It provides hardware-backed isolation of a Secure World from a Normal World. The switch between these two worlds is generally orthogonal to all other capabilities of the processor, thus each world can operate independently of the other while using the same processor core. Memory and peripherals such as display and audio/video controllers are then made aware of the operating world to prevent the Normal World from accessing the information from the Secure World.

The Normal World is managed by Rich Operating System (Rich OS) such as Windows and Android, while the Secure World is managed by Secure OS or Trusted Execution Environment (TEE).

Security Requirements for Cinavia:

Like many other copy protection and DRM systems, the effectiveness of Cinavia relies on its secure and robust implementation in compliant systems. The main resources required by Cinavia, the potential threats to these resources, and security requirements are summarized in Table 1.

TABLE 1
Example Listing of Cinavia Resources, Threats and
Security Requirements

| Resources | Threats | Security Requirements |
|---|---|---|
| Cinavia | Reverse | Confidentiality, integrity and authenticity: |
| Detector | Engineering, | (1) during installation, update and storage, and |
| | Tampering, | (2) before and during execution |
| | Unauthorized | |
| | Access | |
| Copy | Manipulation | Confidentiality, integrity and authenticity |
| Protection | | of Copy Protection Status from |
| Status | | the DRM Module to Cinavia |
| from DRM | | Detector |
| Input Audio | Manipulation | All audio data resulted from AV |
| to Cinavia | | Playback must be provided to Cinavia |
| Detector | | Detector as Input Audio with |
| | | Integrity and authenticity |
| Enforcement | Manipulation | Enforcement Actions must be performed |
| Actions | or | by trusted functions that are capable of |
| | Bypass | controlling or causing the control of the |
| | | output of all AV outputs resulting |
| | | from AV Playback |
| Output | Bypass | All audio outputs must be |
| Audio | Cinavia | controlled by trusted |
| | Detector | functions |

A key requirement as listed above is that all audio visual (AV) outputs resulting from any playback of protected or unprotected audiovisual content must be controlled by trusted functions. An AV Output can be made through one of the following AV Output Interfaces:

(a) Physical AV Interface: the interface with defined electrical (or optical) hardware connectors dedicated for carrying audio signal and video signal such as HDMI, DVI, and Components; or

(b) Network AV Protocol: a proprietary or standardized protocol allowing transmission of audiovisual content (compressed or uncompressed) from one device to another using generic networking connections (such as Ethernet, WiFi, WiFi Direct, Bluetooth, and coaxial cabling) for the purposes of remote display or remote rendering/display of such audiovisual content. Examples of the Network AV Protocols include DLNA, WiDi/Miracast, and BlueTooth A2DP.

When an AV Output is resulted solely from performing functions other than AV Playback (e.g., making phone calls or playing games) or an AV output is made through an interface that is not dedicated to audiovisual content, these AV Output Interfaces may not be required to be controlled by trusted functions.

Status Quo Architecture of AV Playback in ARM TrustZone

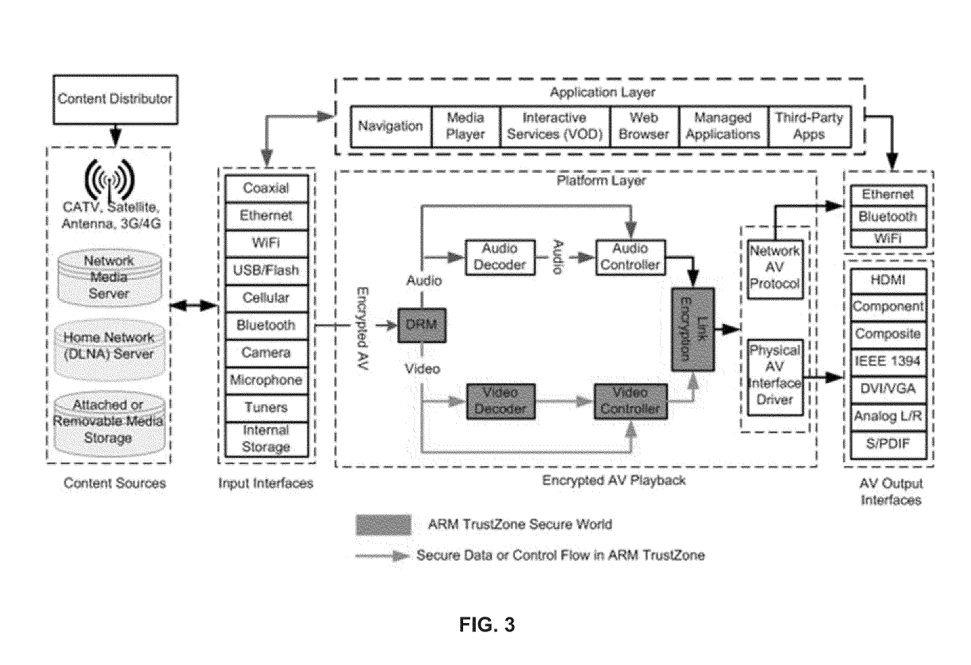

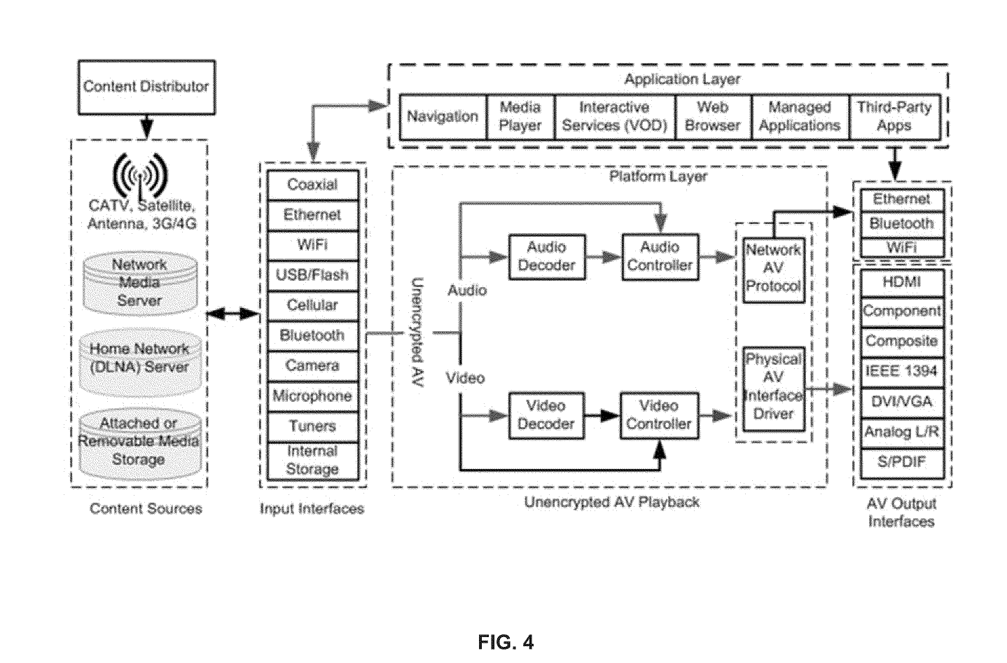

FIG. 3 shows the “status quo” architecture of encrypted AV Playback in the TrustZone. This architecture includes a secure video path in which the video is processed in the Secure World, ranging from decryption, decoding to video output with link encryption, while the audio is processed in the Normal World. The secure components and video path in FIG. 3 include the highlighted components labeled as DRM, Video Decoder, Video Controller, and Link Encryption, and the connections between those components. For unencrypted audiovisual content, both audio and video components are processed in the Normal World as shown in FIG. 4, which depicts the some of the same components as in FIG. 3, but without the DRM, and link encryption components.

Cinavia Implementations in ARM TrustZone

To meet security requirements of Cinavia defined in Table 1 above, in some embodiments, the solution at the platform level includes the following changes to the status quo architecture as shown in FIGS. 3 and 4. In particular, the Cinavia Detector is implemented in the Secure World. Further, all audio and video outputs via Physical AV Interfaces and/or Network AV Protocols are controlled by secure functions in the Secure World not only for playback of encrypted audiovisual content but also for playback of unencrypted audiovisual content. Additionally, enforcement actions are performed by Audio and Video Controllers or Secure OS.

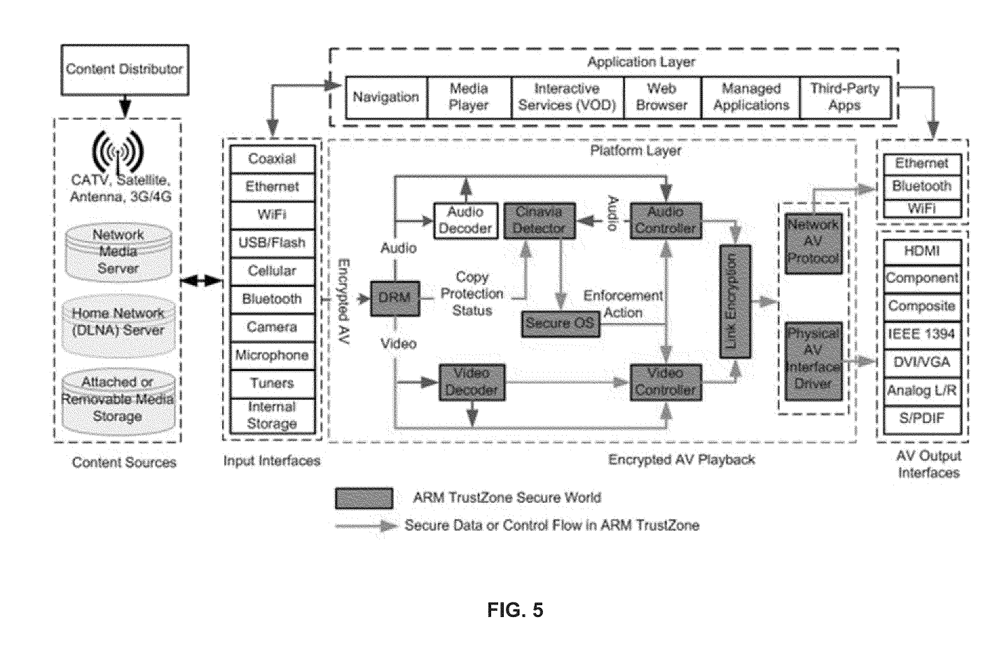

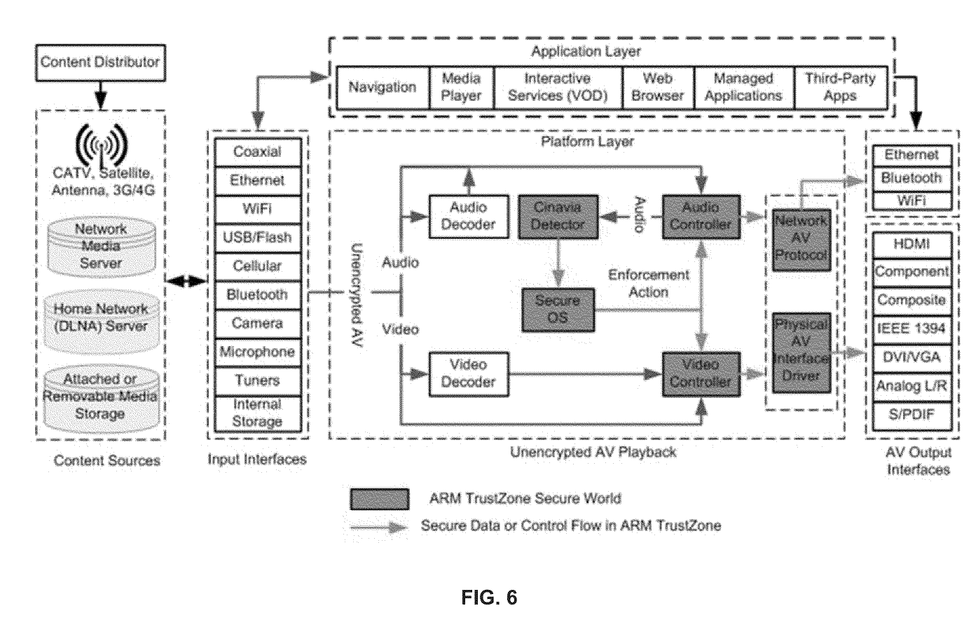

FIGS. 5 and 6 show sample architectures of Cinavia implementation for playback of encrypted and unencrypted audiovisual content, respectively, in a TrustZone-enabled system. In particular, FIG. 6 shows the highlighted components labeled as DRM, Video Decoder, Video Controller. Secure OS. Cinavia Detector, Audio Controller, Link Encryption, Network AV Protocol and Physical AV Interface Driver, as well as certain connections between those components, as being implemented in the secure environment. In FIG. 6, only the Video Controller, Secure OS, Cinavia Detector, Audio Controller, Network AV Protocol and Physical AV Interface Driver, as well as certain connections between those components, are implemented in the secure environment.

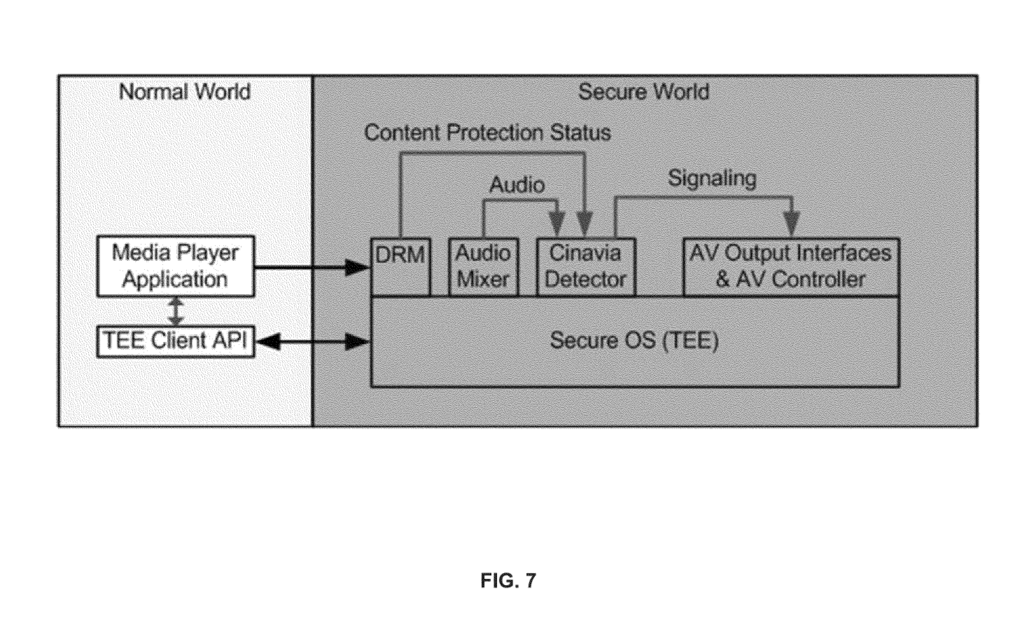

FIG. 7 shows a high-level software stack for Cinavia Implementation in ARM TrustZone for AV Playback. The Secure OS is a separate execution environment that runs alongside the Rich OS. Its applications such as Cinavia Detector and DRM are not only separated from the applications from the Normal World, but also completely isolated from each other in the Secure World.

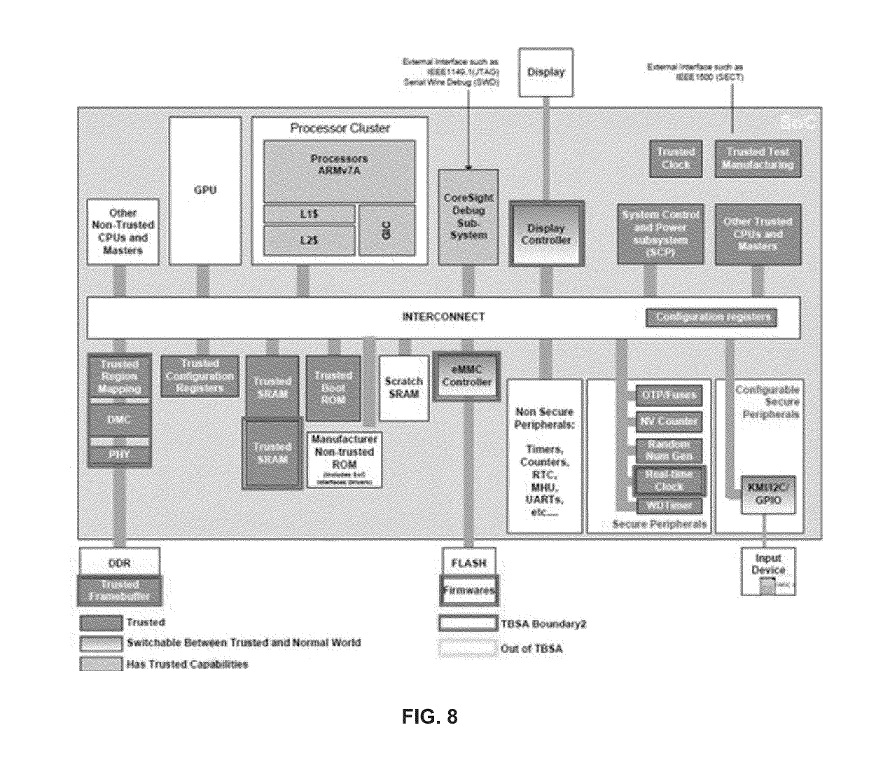

As shown in FIG. 8 the Audio Controller and Audio Output (circled with dashed line) are added onto the diagram of such a typical system that incorporates the minimal security functionality of a TrustZone technology. Like Display Controller, the Audio Controller is switchable between the Normal and Secure World.

One aspect of the disclosed technology relates to a method for embedding a watermark in content that includes receiving content, and embedding the content with a watermark containing information that identifies a plurality of DRM systems and a status of each of the plurality of DRM systems. For example, the status of the DRM can include information regarding whether a particular DRM is on an approved whitelist. Furthermore, the above method can include removing a DRM from a whitelist when a whitelisted DRM has been compromised and subsequently embedding content with a modified DRM version. The watermark can, for example, include whitelist information as a Boolean vector that indicates whether a DRM is trusted or not. Additionally, a player can be provided with a DRM table. The watermark can be read with a watermark detector, and the DRM code and the DRM status are matched in the player. In some embodiments, the DRM code and the DRM status are matched in the detector.

In some embodiments, the above noted method further includes embedding content with a watermark payload communicating a list of revoked DRMs. The watermark payload can carry the DRM revocation information using bit-map revocation, or the watermark payload can carry the DRM revocation information using explicit revocation. In one embodiment, the watermark includes a unique code that defines the plurality of watermarks. DRMs can be identified by a predefined position in a vector.

Another method relates to detecting a watermark in content and includes receiving a content and detecting a watermark in the content where the watermark includes information that identifies a plurality of DRM systems and a status of each of the plurality of DRM systems. Additionally, it is determined whether to play the content on a player based on the status. Further, the DRM status can be stored on the player, and the stored DRM status can by updated.

In another method for embedding a watermark a received content is embedded with a watermark including information that identifies a particular list containing one or more predefined DRMs. Such a list can be a whitelisted DRMs. Such a list can be a list of restricted DRMs.

One system that is implemented according to the disclosed embodiments includes a computer architecture having a normal region and a secure region, where the normal and secure regions are isolated from each other and the secure region processes video and audio content in a secure path in the secure region. Such a system also includes an audio watermark detector implemented in the secure region, where all audio and video outputs are controlled by secure functions in the secure region for encrypted and unencrypted content. The system further includes an audio controller, a video controller, and a secure operating system for controlling enforcement actions in response to signals from the watermark detector. The normal region is managed by a rich operating system and the secure region is managed by a secure operating system, and the applications of the secure operating system are isolated from the normal region and are isolated from each other in the secure region.

The watermark detector in such a system can be a Cinavia detector. Furthermore, the normal region comprises an ARM TrustZone Normal World and the secure region comprises an ARM TrustZone Secure World.

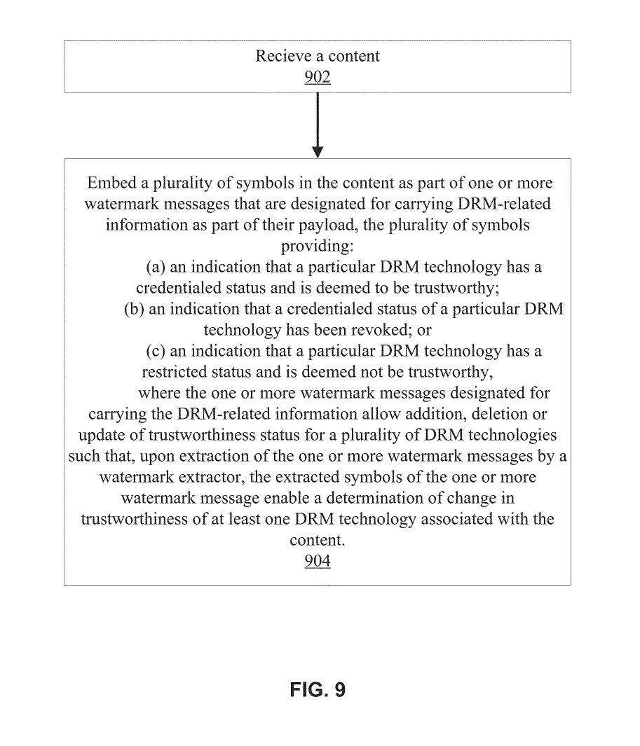

FIG. 9 illustrates a set of operations that can be carried out to signal a change in status of digital rights management (DRM) using embedded watermarks in accordance with an exemplary embodiment. At 902, a multimedia content is received at a content playback device. At 904, a plurality of watermark symbols are embedded in the content using a watermark embedder that is implemented at least partially in electronic circuitry. The plurality of symbols are embedded as part of one or more watermark messages that are designated for carrying DRM-related information. The plurality of symbols provide that (a) a particular DRM technology has a credentialed status and is deemed to be trustworthy, (b) a credentialed status of a particular DRM technology has been revoked, or (c) a particular DRM technology has a restricted status and is deemed not be trustworthy. The one or more watermark messages designated for carrying the DRM-related information allow addition, deletion or update of trustworthiness status for a plurality of DRM technologies such that, upon extraction of the one or more watermark messages by a watermark extractor, the extracted symbols of the one or more watermark message enable a determination of a change in trustworthiness of at least one DRM technology associated with the content.

In some embodiments, each of the one or more watermark messages is divided into a first section indicating a message type field and a second section indicating an information field, where the DRM-related information is embedded as part of the information field of the one or more watermark messages when the message type field is embedded with a value that indicates the associated information field is designated for the DRM-related information. In one exemplary embodiment, the above noted method of FIG. 9 further includes selecting a specific format for embedding the DRM-related information as part of the one or more watermark messages, embedding a first value in the first section of the one or more watermark messages, and embedding the DRM-related information in the specific format in the second section of the one or more watermark messages.

According to one exemplary embodiment, the message type field is 6 bits long and the information field is 44 bits long. In another exemplary embodiment, the message type field when includes a value in a first range of values, indicates that the associated information field is structured in a first format to include the DRM-related information, and when includes a value in a second range of values, indicates that the associated information field is structured in a second format to include the DRM-related information. In some embodiments, the first format represents a Boolean vector in a bitmap format, and the second format represents an explicit listing of a DRM code values.

In another exemplary embodiment, the one or more watermark messages that have a type field value that is indicative of the DRM-related information form a fraction of all watermark messages that are embedded in the content. For example, the fraction is one-half in some embodiments. In yet another exemplary embodiment, the DRM-related information is embedded in the information field of the one or more watermark messages and is formatted as a bitmap structure, where each bit position within the bitmap structure corresponds to a specific DRM technology. In one exemplary embodiment, a first bit value at each position of the bitmap structure field is indicative of trustworthiness of the associated specific DRM technology and a second bit value at each position of the bitmap structure is indicative of lack of trustworthiness of the associated specific DRM technology. In another exemplary embodiment, the bitmap structure is associated with a table that provides a mapping between the bitmap structure and a listing of corresponding DRM technologies.

In some embodiments, the DRM-related information includes a revocation list that is embedded in the information field of the one or more watermark messages and is formatted as a plurality of multi-bit codes. Each multi-bit code identifies a specific DRM technology, and the revocation list identifies a plurality of untrustworthy DRM technologies whose credentialed status have been revoked. In one exemplary embodiment, each multi-bit code is 8 bits long, and each of the one or more watermark messages allows inclusion of five 8-bit codes in the content. In another exemplary embodiment, inclusion of the revocation list in the one or more watermark messages is signaled using the first section the one or more watermark messages that is designated for carrying a message type field.

According to another exemplary embodiment, the above note method of FIG. 9 further includes receiving an indication of a change in trustworthiness of a specific DRM technology, where the embedded plurality of symbols convey the change in trustworthiness of the specific DRM technology.

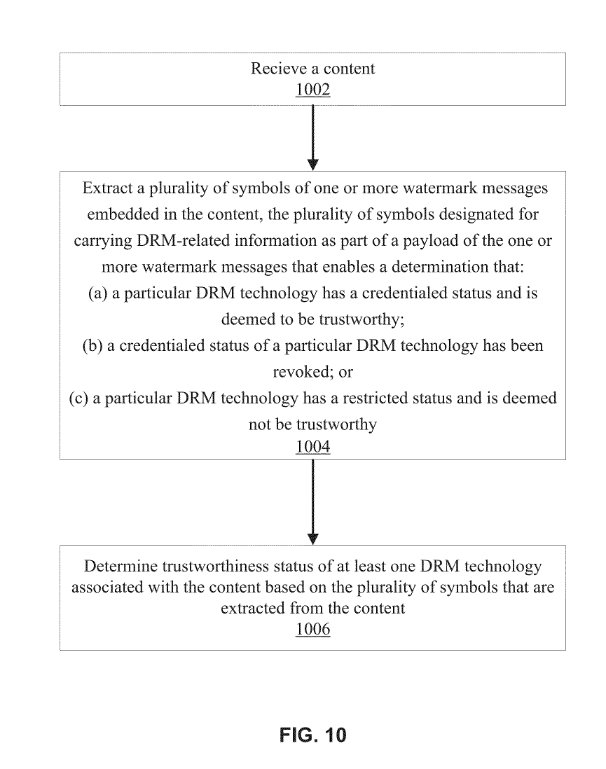

FIG. 10 illustrates a set of operations that can be carried out for determination of DRM status associated with a multimedia content in accordance with an exemplary embodiment. At 1002, a multimedia content is received. At 1004, a plurality of symbols of one or more watermark messages that are embedded in the content are extracted. For example, a watermark extractor that is implemented at least partially in electronic circuitry can be used for extracting those symbols. The plurality of symbols designated for carrying DRM-related information enable the determination that (a) a particular DRM technology has a credentialed status and is deemed to be trustworthy, (b) a credentialed status of a particular DRM technology has been revoked, or (c) a particular DRM technology has a restricted status and is deemed not be trustworthy. At 1006, trustworthiness status of at least one DRM technology associated with the content is determined based on the plurality of symbols that are extracted from the content.

In one exemplary embodiment, each of the one or more watermark messages is divided into a first section indicating a message type field and a second section indicating an information field, where the DRM-related information is included as part of the information field of the one or more watermark messages when the message type field includes a value that indicates the associated information field is designated for the DRM-related information. In another exemplary embodiment, the above noted method of FIG. 10 further includes determining, from the plurality of the symbols that are extracted from the content, a first value that is included in the first section of the one or more watermark messages, indicating that the DRM-related information is embedded in a specific format, and obtaining the DRM-related information in the specific format from the second section of the one or more watermark messages. In some embodiments, the message type field is 6 bits long and the information field is 44 bits long.

According to another exemplary embodiment, message type field having a value in a first range of values indicates that the associated information field is structured in a first format to include the DRM-related information, and message type field having a value in a second range of values indicates that the associated information field is structured in a second format to include the DRM-related information. In another exemplary embodiment, the above noted method of FIG. 10 further includes accessing a whitelist indicative of an initial set of DRM technologies with the credentialed status, where the DRM-related information recovered from the one or more watermark messages enables addition, deletion or update of trustworthiness status a specific DRM technology. In one exemplary embodiment, the DRM-related information recovered from the one or more watermark messages enables one or more of: revocation of a trusted status of a specific DRM technology that is included in the whitelist, placement of a specific DRM technology on a restricted credentialed list, or addition of a specific DRM technology to the whitelist. In some embodiments, all DRM technologies that are not listed in the whitelist are considered untrustworthy.

In yet another exemplary embodiment, the method that is described in connection with FIG. 10 includes determining that the content is protected by the specific DRM and the specific DRM is listed on the whitelist, determining whether or not the DRM-related information obtained from the one or more watermarks indicates a change in trustworthiness of the specific DRM technology. Upon a determination that trustworthiness of the specific DRM technology is unchanged, allowing access to the content in conformance with a predetermined content use policy, and upon a determination that trustworthiness of the specific DRM technology is changed, restricting access to the content.

Another aspect of the disclosed embodiments relates to a electronic device that includes a DRM component, a watermark detector, a secure operating system component, an audio controller, a video controller, an audio decoder, a video decoder, and a link encryption component. The DRM component is coupled to the video decoder, the video controller, the audio controller and to the watermark detector. The watermark detector is coupled to secure operating system component. The secure operating system component is coupled to the audio controller and to the video controller. The audio controller and the video controller are coupled to the link encryption controller, respectively. The audio decoder is coupled to the watermark detector and to the audio controller. The video decoder is coupled to the video controller. In such a systems, the watermark detector is configured to extract a plurality of symbols of one or more watermark messages embedded in a content. The plurality of symbols designated for carrying DRM-related information enable the determination that (a) a particular DRM technology has a credentialed status and is deemed to be trustworthy, (b) a credentialed status of a particular DRM technology has been revoked, or (c) particular DRM technology has a restricted status and is deemed not be trustworthy. The device is also configured to determine trustworthiness status of at least one DRM technology associated with the content based on the plurality of symbols that are extracted from the content.

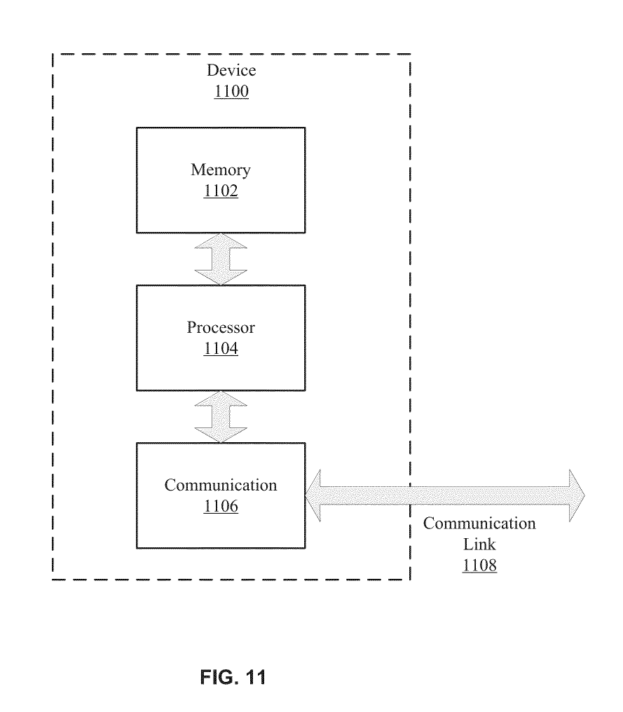

FIG. 11 illustrates a block diagram of a device 1100 within which various disclosed embodiments may be implemented. The device 1100 comprises at least one processor 1104 and/or controller, at least one memory 1102 unit that is in communication with the processor 1104, and at least one communication unit 1106 that enables the exchange of data and information, directly or indirectly, through the communication link 1108 with other entities, devices, databases and networks. The communication unit 1106 may provide wired and/or wireless communication capabilities in accordance with one or more communication protocols, and therefore it may comprise the proper transmitter/receiver, antennas, circuitry and ports, as well as the encoding/decoding capabilities that may be necessary for proper transmission and/or reception of data and other information. The exemplary device 1100 of FIG. 11 may be integrated as part of any devices or components described in this document to carry out any of the disclosed methods.

The components or modules that are described in connection with the disclosed embodiments can be implemented as hardware, software, or combinations thereof. For example, a hardware implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application.

Various embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), Blu-ray Discs, etc. Therefore, the computer-readable media described in the present application include non-transitory storage media. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

For example, one aspect of the disclosed embodiments relates to a computer program product that is embodied on a non-transitory computer readable medium. The computer program product includes program code for carrying out any one or and/or all of the operations of the disclosed embodiments.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products, as well as in different sequential orders. Any embodiment may further be combined with any other embodiment.

What is claimed is:

1. A method for determination of digital rights management (DRM) status associated with a multimedia content, comprising:
receiving a content;
extracting a plurality of symbols of one or more watermark messages embedded in the content using a watermark extractor that is implemented at least partially in electronic circuitry, the plurality of symbols designated for carrying DRM-related information as part of a payload of the one or more watermark messages that enables a determination that:
(a) a particular DRM technology has a credentialed status and is deemed to be trustworthy;
(b) a credentialed status of a particular DRM technology has been revoked; or
(c) a particular DRM technology has a restricted status and is deemed not be trustworthy; and
determining trustworthiness status of at least one DRM technology associated with the content based on the plurality of symbols that are extracted from the content.

2. The method of claim 1, wherein each of the one or more watermark messages is divided into a first section indicating a message type field and a second section indicating an information field, wherein the DRM-related information is included as part of the information field of the one or more watermark messages when the message type field includes a value that indicates the associated information field is designated for the DRM-related information.

3. The method of claim 2, further comprising:
determining, from the plurality of the symbols that are extracted from the content, a first value that is included in the first section of the one or more watermark messages, indicating that the DRM-related information is embedded in a specific format; and
obtaining the DRM-related information in the specific format from the second section of the one or more watermark messages.

4. The method of claim 2, wherein the message type field is 6 bits long and the information field is 44 bits long.

5. The method of claim 2, wherein the message type field having a value in a first range of values indicates that the associated information field is structured in a first format to include the DRM-related information, and message type field having a value in a second range of values indicates that the associated information field is structured in a second format to include the DRM-related information.

6. The method of claim 5, wherein the first format represents a Boolean vector in a bitmap format, and the second format represents an explicit listing of a DRM code values.

7. The method of claim 2, wherein the one or more watermark messages having a type field value that is indicative of the DRM-related information form a fraction of all watermark messages that are embedded in the content.

8. The method of claim 7, wherein the fraction is one-half.

9. The method of claim 2, comprising obtaining the DRM-related information from the information field of the one or more watermark messages that is formatted as a bitmap structure, wherein each bit position within the bitmap structure corresponds to a specific DRM technology.

10. The method of claim 9, wherein a first bit value at each position of the bitmap structure field is indicative of trustworthiness of the associated specific DRM technology and a second bit value at each position of the bitmap structure is indicative of lack of trustworthiness of the associated specific DRM technology.

11. The method of claim 9, wherein the bitmap structure is associated with a table that provides a mapping between the bitmap structure and a listing of corresponding DRM technologies.

12. The method of claim 2, wherein the DRM-related information includes a revocation list that is included in the information field of the one or more watermark messages and is formatted as a plurality of multi-bit codes, wherein each multi-bit code identifies a specific DRM technology, and the revocation list identifies a plurality of untrustworthy DRM technologies whose credentialed status have been revoked.

13. The method of claim 12, wherein each multi-bit code is 8 bits long, and each of the one or more watermark messages allows recovery of five 8-bit codes.

14. The method of claim 12, wherein inclusion of the revocation list in the one or more watermark messages is signaled by a specific value that is recovered from the first section the one or more watermark messages that is designated for carrying a message type field.

15. The method of claim 1, further comprising accessing a whitelist indicative of an initial set of DRM technologies with the credentialed status, wherein the DRM-related information recovered from the one or more watermark messages enables addition, deletion or update of trustworthiness status a specific DRM technology.

16. The method of claim 15, wherein the DRM-related information recovered from the one or more watermark messages enables one or more of:
revocation of a trusted status of a specific DRM technology that is included in the whitelist,
placement of a specific DRM technology on a restricted credentialed list, or
addition of a specific DRM technology to the whitelist.

17. The method of claim 15, wherein all DRM technologies that are not listed in the whitelist are considered untrustworthy.

18. The method of claim 15, wherein:
determining that the content is protected by the specific DRM and the specific DRM is listed on the whitelist;
determining whether or not the DRM-related information obtained from the one or more watermarks indicates a change in trustworthiness of the specific DRM technology,
upon a determination that trustworthiness of the specific DRM technology is unchanged, allowing access to the content in conformance with a predetermined content use policy, and
upon a determination that trustworthiness of the specific DRM technology is changed, restricting access to the content.

19. A device, comprising:
a processor; and
a memory comprising processor executable code, the processor executable code, when executed by the processor causes the device to:
receive a content;
extract a plurality of symbols of one or more watermark messages embedded in the content, the plurality of symbols designated for carrying DRM-related information as part of a payload of the one or more watermark messages that enables a determination that:
(a) a particular DRM technology has a credentialed status and is deemed to be trustworthy;
(b) a credentialed status of a particular DRM technology has been revoked; or
(c) a particular DRM technology has a restricted status and is deemed not be trustworthy; and
determine trustworthiness status of at least one DRM technology associated with the content based on the plurality of symbols that are extracted from the content.

20. The device of claim 19, wherein each of the one or more watermark messages is divided into a first section indicating a message type field and a second section indicating an information field, wherein the DRM-related information is included as part of the information field of the one or more watermark messages when the message type field includes a value that indicates the associated information field is designated for the DRM-related information.

21. The device of claim 20, wherein the processor executable code, when executed by the processor causes the device to:
determine, from the plurality of the symbols that are extracted from the content, a first value that is included in the first section of the one or more watermark messages, indicating that the DRM-related information is in a specific format; and
obtain the DRM-related information in the specific format from the second section of the one or more watermark messages.

22. The device of claim 20, wherein the message type field is 6 bits long and the information field is 44 bits long.

23. The device of claim 20, wherein the message type field having a value in a first range of values indicates that the associated information field is structured in a first format to include the DRM-related information, and message type field having a value in a second range of values indicates that the associated information field is structured in a second format to include the DRM-related information.

24. The device of claim 23, wherein the first format represents a Boolean vector in a bitmap format, and the second format represents an explicit listing of a DRM code values.

25. The device of claim 20, wherein the one or more watermark messages with a type field value that is indicative of the DRM-related information form a fraction of all watermark messages that are extracted from the content.

26. The device of claim 7, wherein the fraction is one-half.

27. The device of claim 20, wherein the processor executable code, when executed by the processor, causes the device to obtain the DRM-related information from the information field of the one or more watermark messages that is formatted as a bitmap structure, wherein each bit position within the bitmap structure corresponds to a specific DRM technology.

28. The device of claim 27, wherein a first bit value at each position of the bitmap structure field is indicative of trustworthiness of the associated specific DRM technology and a second bit value at each position of the bitmap structure is indicative of lack of trustworthiness of the associated specific DRM technology.

29. The device of claim 27, wherein the bitmap structure is associated with a table that provides a mapping between the bitmap structure and a listing of corresponding DRM technologies.

30. The device of claim 20, wherein the DRM-related information includes a revocation list that is included in the information field of the one or more watermark messages and is formatted as a plurality of multi-bit codes, wherein each multi-bit code identifies a specific DRM technology, and the revocation list identifies a plurality of untrustworthy DRM technologies whose credentialed status have been revoked.

31. The device of claim 30, wherein each multi-bit code is 8 bits long, and each of the one or more watermark messages allows recovery of five 8-bit codes.

32. The device of claim 30, wherein inclusion of the revocation list in the one or more watermark messages is signaled by a specific value that is recovered from the first section the one or more watermark messages that is designated for carrying a message type field.

33. The device of claim 19, wherein the processor executable code, when executed by the processor causes the device to access a whitelist indicative of an initial set of DRM technologies with the credentialed status, wherein the DRM-related information recovered from the one or more watermark messages enables addition, deletion or update of trustworthiness status a specific DRM technology.

34. The device of claim 33, wherein the DRM-related information recovered from the one or more watermark messages enables one or more of:
revocation of a trusted status of a specific DRM technology that is included in the whitelist,
placement of a specific DRM technology on a restricted credentialed list, or
addition of a specific DRM technology to the whitelist.

35. The device of claim 33, wherein all DRM technologies that are not listed on the whitelist are considered untrustworthy.

36. The device of claim 19, wherein the processor executable code, when executed by the processor causes the device to:
determine that the content is protected by the specific DRM and the specific DRM is listed on the whitelist;
determine whether or not the DRM-related information obtained from the one or more watermarks indicates a change in trustworthiness of the specific DRM technology,
upon a determination that trustworthiness of the specific DRM technology is unchanged, provide an indication that access to the content is allowed in conformance with a predetermined content use policy, and
upon a determination that trustworthiness of the specific DRM technology is changed, provide an indication that access to the content is restricted.

37. The device of claim 19, wherein the device is part of a watermark extractor that is implemented as part of a mobile device or a consumer electronic device.

38. The device of claim 19, wherein the device is implemented as part of a secure section of an electronic device, the electronic device including the secure section and a normal section, the secure section including a separate execution environment than the normal section and isolated from the normal section to thwart analysis and modification of data and signals within the secure section.

39. A computer program product, embodied on one or more non-transitory computer readable media, comprising:
program code for receiving a content;
program code for extracting a plurality of symbols of one or more watermark messages embedded in the content, the plurality of symbols designated for carrying DRM-related information as part of a payload of the one or more watermark messages that enables a determination that:
(a) a particular DRM technology has a credentialed status and is deemed to be trustworthy;
(b) a credentialed status of a particular DRM technology has been revoked; or
(c) a particular DRM technology has a restricted status and is deemed not be trustworthy; and
program code for determining trustworthiness status of at least one DRM technology associated with the content based on the plurality of symbols that are extracted from the content.

40. An electronic device, comprising:
a DRM component;
a watermark detector;
a secure operating system component;
an audio controller;
a video controller;
an audio decoder;
a video decoder; and
a link encryption component, wherein
the DRM component is coupled to the video decoder, the video controller, the audio controller and to the watermark detector;
the watermark detector is coupled to secure operating system component;
the secure operating system component is coupled to the audio controller and to the video controller;
the audio controller and the video controller are coupled to the link encryption controller, respectively;
the audio decoder is coupled to the watermark detector and to the audio controller;
the video decoder is coupled to the video controller, and wherein
the watermark detector is configured to extract a plurality of symbols of one or more watermark messages embedded in a content, the plurality of symbols designated for carrying DRM-related information as part of a payload of the one or more watermark messages that enables a determination that:
(a) a particular DRM technology has a credentialed status and is deemed to be trustworthy;
(b) a credentialed status of a particular DRM technology has been revoked; or
(c) particular DRM technology has a restricted status and is deemed not be trustworthy, and
determine trustworthiness status of at least one DRM technology associated with the content based on the plurality of symbols that are extracted from the content.

41. A method for dynamic signaling of digital rights management (DRM) status in a multimedia content, comprising:
receiving a content; and
embedding a plurality of symbols in the content using a watermark embedder that is implemented at least partially in electronic circuitry, the plurality of symbols embedded in one or more watermark messages that are designated for carrying DRM-related information as part of their payload, the plurality of symbols providing:
(a) an indication that a particular DRM technology has a credentialed status and is deemed to be trustworthy;
(b) an indication that a credentialed status of a particular DRM technology has been revoked; or
(c) an indication that a particular DRM technology has a restricted status and is deemed not be trustworthy,
wherein the one or more watermark messages designated for carrying the DRM-related information allow addition, deletion or update of trustworthiness status for a plurality of DRM technologies such that, upon extraction of the one or more watermark messages by a watermark extractor, the extracted symbols of the one or more watermark messages enable a determination of change in trustworthiness of at least one DRM technology associated with the content.

42. The method of claim 41, wherein each of the one or more watermark messages is divided into a first section indicating a message type field and a second section indicating an information field, wherein the DRM-related information is embedded as part of the information field of the one or more watermark messages when the message type field is embedded with a value that indicates the associated information field is designated for the DRM-related information.

43. The method of claim 42, further comprising:
selecting a specific format for embedding the DRM-related information as part of the one or more watermark messages;
embedding a first value in the first section of the one or more watermark messages; and
embedding the DRM-related information in the specific format in the second section of the one or more watermark messages.

44. The method of claim 42, wherein the message type field is 6 bits long and the information field is 44 bits long.

45. The method of claim 42, wherein the message type field having a value in a first range of values indicates that the associated information field is structured in a first format to include the DRM-related information, and message type field having a value in a second range of values indicates that the associated information field is structured in a second format to include the DRM-related information.

46. The method of claim 45, wherein the first format represents a Boolean vector in a bitmap format, and the second format represents an explicit listing of a DRM code values.

47. The method of claim 42, wherein the one or more watermark messages having a type field value that is indicative of the watermark messages that are used for carry the DRM-related information form a fraction of all watermark messages that are embedded in the content.

48. The method of claim 47, wherein the fraction is one-half.

49. The method of claim 42, wherein the DRM-related information is embedded in the information field of the one or more watermark messages and is formatted as a bitmap structure, wherein each bit position within the bitmap structure corresponds to a specific DRM technology.

50. The method of claim 49, wherein a first bit value at each position of the bitmap structure field is indicative of trustworthiness of the associated specific DRM technology and a second bit value at each position of the bitmap structure is indicative of lack of trustworthiness of the associated specific DRM technology.

51. The method of claim 49, wherein the bitmap structure is associated with a table that provides a mapping between the bitmap structure and a listing of corresponding DRM technologies.

52. The method of claim 42, wherein the DRM-related information includes a revocation list that is embedded in the information field of the one or more watermark messages and is formatted as a plurality of multi-bit codes, wherein each multi-bit code identifies a specific DRM technology, and the revocation list identifies a plurality of untrustworthy DRM technologies whose credentialed status have been revoked.

53. The method of claim 52, wherein each multi-bit code is 8 bits long, and each of the one or more watermark messages allows inclusion of five 8-bit codes in the content.

54. The method of claim 52, wherein inclusion of the revocation list in the one or more watermark messages is signaled using the first section the one or more watermark messages that is designated for carrying a message type field.

55. The method of claim 41, further comprising receiving an indication of a change in trustworthiness of a specific DRM technology, wherein the embedded plurality of symbols convey the change in trustworthiness of the specific DRM technology.

56. A device, comprising:
a processor and
a memory comprising processor executable code, the processor executable code when executed by the processor causes the device to:
receive a content; and
embed a plurality of symbols in the content as part of one or more watermark messages that are designated for carrying DRM-related information as part of their payload, the plurality of symbols providing:
(a) an indication that a particular DRM technology has a credentialed status and is deemed to be trustworthy;
(b) an indication that a credentialed status of a particular DRM technology has been revoked; or
(c) an indication that a particular DRM technology has a restricted status and is deemed not be trustworthy,
wherein the one or more watermark messages designated for carrying the DRM-related information allow addition, deletion or update of trustworthiness status for a plurality of DRM technologies such that, upon extraction of the one or more watermark messages by a watermark extractor, the extracted symbols of the one or more watermark messages enable a determination of a change in trustworthiness of at least one DRM technology associated with the content.

57. The device of claim 56, wherein each of the one or more watermark messages is divided into a first section indicating a message type field and a second section indicating an information field, and wherein the processor executable code when executed by the processor configures the device to embed the DRM-related information as part of the information field of the one or more watermark messages and embed the message type field with a value that indicates the associated information field is designated for the DRM-related information.

58. The device of claim 57, wherein the processor executable code when executed by the processor configures the device to select a specific format for embedding the DRM-related information as part of the one or more watermark messages, and embed a first value in the first section of the one or more watermark messages, and embed the DRM-related information in the specific format in the second section of the one or more watermark messages.

59. The device of claim 57, wherein the message type field is 6 bits long and the information field is 44 bits long.

60. The device of claim 57, wherein the message type field having a value in a first range of values indicates that the associated information field is structured in a first format to include the DRM-related information, and message type field having a value in a second range of values indicates that the associated information field is structured in a second format to include the DRM-related information.

61. The device of claim 60, wherein the first format represents a Boolean vector in a bitmap format, and the second format represents an explicit listing of a DRM code values.

62. The device of claim 57, wherein the processor executable code when executed by the processor configures the device to select a fraction of all watermark embedding opportunities for embedding the DRM-related information.

63. The device of claim 62, wherein the fraction is one-half.

64. The device of claim 57, wherein the processor executable code when executed by the processor configures the device to embed the DRM-related information in the information field of the one or more watermark messages and to format the DRM-related information as a bitmap structure, wherein each bit position within the bitmap structure corresponds to a specific DRM technology.

65. The device of claim 64, wherein a first bit value at each position of the bitmap structure field is indicative of trustworthiness of the associated specific DRM technology and a second bit value at each position of the bitmap structure is indicative of lack of trustworthiness of the associated specific DRM technology.

66. The device of claim 64, wherein the bitmap structure is associated with a table that provides a mapping between the bitmap structure and a listing of corresponding DRM technologies.

67. The device of claim 57, wherein the processor executable code when executed by the processor configures the device to include a revocation list in the DRM-related information that is embedded in the information field of the one or more watermark messages and to format the DRM-related information as a plurality of multi-bit codes, wherein each multi-bit code identifies a specific DRM technology, and the revocation list identifies a plurality of untrustworthy DRM technologies whose credentialed status have been revoked.

68. The device of claim 67, wherein each multi-bit code is 8 bits long, and each of the one or more watermark messages allows inclusion of five 8-bit codes in the content.

69. The device of claim 67, wherein the processor executable code when executed by the processor configures the device to signal inclusion of the revocation list in the one or more watermark messages using the first section the one or more watermark messages that is designated for carrying a message type field.

70. The device of claim 56, wherein the processor executable code when executed by the processor further configures the device to receive an indication of a change in trustworthiness of a specific DRM technology, wherein the embedded plurality of symbols convey the change in trustworthiness of the specific DRM technology.

71. A computer program product, embodied on one or more non-transitory computer readable media, comprising:
program code for receiving a content; and
program code for embedding a plurality of symbols in the content as part of one or more watermark messages that are designated for carrying DRM-related information as part of their payload, the plurality of symbols providing:
(a) an indication that a particular DRM technology has a credentialed status and is deemed to be trustworthy;
(b) an indication that a credentialed status of a particular DRM technology has been revoked; or
(c) an indication that a particular DRM technology has a restricted status and is deemed not be trustworthy,
wherein the one or more watermark messages designated for carrying the DRM-related information allow addition, deletion or update of trustworthiness status for a plurality of DRM technologies such that, upon extraction of the one or more watermark messages by a watermark extractor, the extracted symbols of the one or more watermark messages enable a determination of a change trustworthiness of at least one DRM technology associated with the content.
